(19) United States
(12) Patent Application Publication
(10) Pub. No.: US 2021/0216072 A1
(43) Pub. Date: Jul. 15, 2021

(54) Autonomous Fire Vehicle

(71) Applicant: Robotic Research, LLC, Gaithersburg, MD (US)

(72) Inventors: Alberto Daniel Lacaze, Potomac, MD (US); Karl Nicholas Murphy, Rockville, MD (US)

(73) Assignee: Alberto Daniel Lacaze, Gaithersburg, MD (US)

(21) Appl. No.: 16/740,622

(22) Filed: Jan. 13, 2020

(51) Int. Cl. G05D 1/02; B62D 6/00; B60R 11/04; G05D 1/00; A62C 27/00; A62C 31/00; G06N 3/08

(52) U.S. Cl. CPC G05D 1/0212; B62D 6/00; B60R 11/04; G05D 1/0011; G05D 2201/0207; A62C 27/00; A62C 31/00; G06N 3/08; G05D 1/0094

(57) ABSTRACT

This invention relates to the development of an autonomous fire vehicle that is capable of performing one or more of the following functions: detecting water supplies such as a fire hydrant or other sources of water suitable for firefighting, detecting the location of a fire, detecting the location of other fire/police/first responder vehicles, detection of smoke, and analysis of smoke/fire content to determine type of fuel being burned. The autonomous fire vehicle contains a drive by wire kit, a database storing the collection routes, a database storing the collection routes, a database of rules of the road or other legal allowable behavior, sensors for detecting the pedestrians, cars, and other road obstacles, and a control system that controls the vehicle to follow routes while performing the above functions.

### CROSS-REFERENCES TO OTHER APPLICATIONS

None.

### STATEMENT REGARDING FEDERAL SPONSORSHIP

No part of this invention was a result of any federally sponsored research.

### FIELD OF THE INVENTION

The invention pertains to the development of an autonomous fire engine that can perform many of the functions of human firefighters.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND

The statements in this section merely provide background information related to the present disclosure and may not constitute prior art.

An intelligent fire vehicle capable of automatically avoiding obstacles has been developed. It is unmanned and used for preventing fires. Here the fire source can be efficiently and quickly found by utilizing the camera and the fire can be distinguished the first time and the fire scene is reported to the main console. The intelligent fire engine can play a big role especially in a case where there is a dangerous fire ground where people cannot get close. This invention is disclosed in CN106512267A.

There have been no reports in the patent literature of autonomous fire engines which can perform many of the functions that are typically performed by human firefighters that are stationed inside fire engines. These types of functions typically performed by humans include detecting water supplies such as fire hydrants or other sources of water suitable for firefighting, detecting the location of a fire, detecting the location of other fire/police/first responder vehicles, detection of smoke, and analysis of smoke/fire content to determine type of fuel being burned.

### SUMMARY OF THE INVENTION

To minimize the limitations in the prior art, and to minimize other limitations that will be apparent upon reading and understanding the present specification, the present invention pertains to the development of autonomous fire engines that perform many of the functions that are typically performed by human firefighters. These functions include detecting water supplies such as fire hydrants or other sources of water suitable for firefighting, detecting the location of a fire, detecting the location of other fire/police/first responder vehicles, detection of smoke, and analysis of smoke/fire content to determine type of fuel being burned.

This autonomous fire engine or vehicle has a drive by wire kit, a database which stores the collection routes, a database of the different rules of the road and/or other legal allowable behavior, sensors for detecting the pedestrians, cars, and other road obstacles, and a control system that controls the vehicle to follow routes while performing one or more of the above functions that are typically performed by humans inside fire engines.

### BRIEF DESCRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Schematic of the basic system of the autonomous fire vehicle.

FIG. 2—Schematic of the fire vehicle having sensors that recognize the location of the fire and water sources and park in a location that optimizes firefighting.

FIG. 3—Schematic that shows that the fire vehicle can use its sensors to create a map of the area, including location and type of buildings, vehicles, people, vegetation, etc.

FIG. 4—Schematic that shows that the fire vehicle can control an automated ladder to reach desired locations.

FIG. 5—Schematic that shows that the fire vehicle can have an external speaker to signal other vehicles or people.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

The present invention pertains to the development of an autonomous fire vehicle that is designed to follow routes comprising an autonomous vehicle with a drive by wire kit, a database storing the collection routes, a database of rules of the road and/or other legal allowable behavior, sensors for detecting the pedestrians, cars, and other road obstacles, and a control system that controls the vehicle to follow routes while performing one or more functions that are typically performed by humans. These types of functions include detecting water supplies such as fire hydrants or other sources of water that are suitable for firefighting, detecting the location of the fire, detecting the location of other fire/police/first responder vehicles, detection of smoke, and analysis of smoke/fire content to determine type of fuel being burned.

A drive-by-wire is a catch-all term that can refer to a number of electronic systems that either augment or completely replace traditional mechanical controls. There are three main vehicle control systems that are commonly replaced with electronic controls: throttle, brakes, and steering. A throttle is a device controlling the flow of fuel or power to an engine.

The autonomous fire vehicle is provided the location of the fire from an emergency signal/call/communication for help or an alarm and the vehicle uses the road network to chart and follow a route that minimizes the time to the location while still following rules of the road.

The autonomous fire vehicle after recognizing the location of the water supplies automatically positions itself in a position that will find a position and park in that position while taking under consideration the distance from the fire and the source of water.

The autonomous fire vehicle is further equipped with a mechanism that allows it to automatically direct a stream of water to the source or above it. It then uses the fire detection and localization to point the firehose and spicket towards the fire. The system adjusts the bearing and tilt of the water hose as well as controls the water flow to aim the water at the fire.

The autonomous fire vehicle has air composition sensors to detect the fuel that is being burned in the fire and has a system for determining the recommended fire extinguishing method which is water vs. powder vs. other firefighting mixtures.

The autonomous fire vehicle is equipped with speakerphones that are used to direct humans out of the area before the firefighting actions.

The autonomous fire vehicle uses its own sensors to create a map of the area. The map can contain doorways, windows, locations of other vehicles, location of trees/vegetation, location of sources of fuel, location of humans/animals. The system is capable of creating a report that can help the local or remote incident commander understand the scene, and aid with the firefighting.

The autonomous fire vehicles partition the space as to attack the fire from different directions. The directions of attack is optimized by an expert system using the map collected of the area, can be predetermined based on the building or can be provided by an incident commander.

The autonomous fire vehicle system where the water stream is adjusted depending on the structure type and the location of windows. The vehicle may point the water stream to windows and doorways, or at holes in the roof of the building.

Two or more autonomous vehicles can adjust their streams to increase the water throughput in a particular area. The autonomous fire vehicle can control bearing/tilt/extension of a ladder towards a window, balcony, or roof of the building. The decision of when to extend the ladder can be performed by commands from a remote/local incident commander or aided by the human detection algorithms inherent to the vehicle.

The autonomous truck in route to the incident has a set of emergency rules that allows it to overcome the standard rules of the road. These extended set of rules may allow the truck to cross a red traffic signal while in this emergency modality, exceed the speed limit or cross into oncoming traffic or block the road to other vehicles to stop.

The autonomous fire truck collects evidence in the form of video/pictures/audio or other sensor information to provide after action review mechanisms to understand the cause of the fire. The autonomous fire truck sends information to other vehicles in the vicinity to move out of the way, park by the side of the road, or open a lane.

In this system, a remote fire/police officer can remotely take over the autonomous truck and the remote operator may talk through a speakerphone, or teleoperate the steering and/or acceleration and brake of the autonomous vehicle.

In the system, the autonomous fire vehicle can illuminate an area where the fire/smoke is detected.

The autonomous fire vehicle can call an ambulance or other fire/rescue vehicle given the particular detection that is sensed.

In the system, the autonomous fire vehicle generates a report on the information of the detection, location, license plate, video, pictures, audio, and/or other sensor information and sends it to a centralized headquarters.

In this system, the autonomous fire vehicle has fire personnel on board that is performing tasks that are unrelated to driving.

In this system, the autonomous fire vehicle uses the sensors necessary for autonomous mobility for the detection.

In this system, the detection is performed by using camera or thermal imagery or LADAR.

In this system, the detections by the autonomous fire vehicle are performed by using deep learning or other learning techniques to improve the classification capabilities of the system. The autonomous fire vehicle is directed to areas that have more crime, more tickets, more probability of finding someone committing an infraction.

In this system, the autonomous fire vehicle also has a database of areas where to station in order to minimize response time. As an example, the system may park close to a factory complex that is further away from a fire station and wait until called in action.

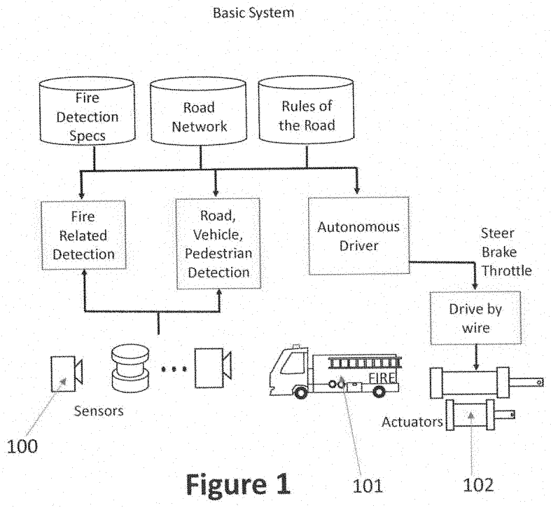

FIG. 1 shows a schematic of the basic system in which sensors (100) are used to detect things related to fires as well as roads, vehicles, and pedestrians. The detected features are compared to different databases such as those of fire detection specs, road network, and rules of the road. The information is then passed on to the autonomous driver which has a drive-by-wire system with steer brake throttle which is connected to actuators (102) in the autonomous fire vehicle (101).

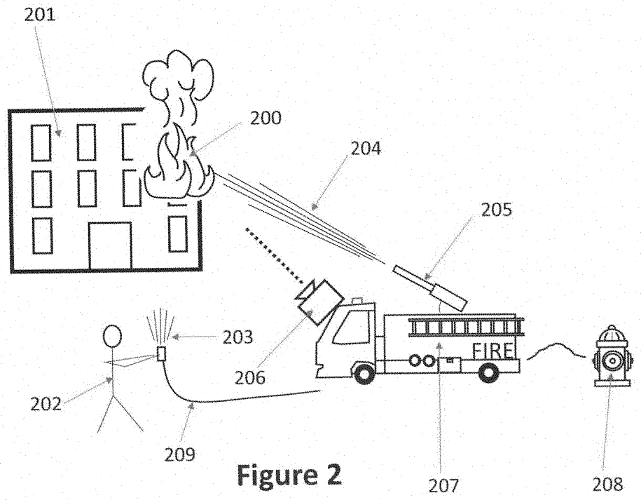

FIG. 2 shows that the autonomous fire vehicle (207) can have sensors (206) that recognize the location of the fire and water sources and park in a location that optimizes firefighting. It can have an automated nozzle (205) that sprays water (204) on the fire. In this example, it can be seen that there is a building (201) in which there is a fire (200) and smoke coming out of the fire (200). The autonomous fire vehicle (207) gets water from the fire hydrant (208) and sprays water (204) using the automated nozzle (205). In addition, there is a human (202) in the ground that also has a fire hose to spray the water (203) onto the fire (200) in the burning building (201).

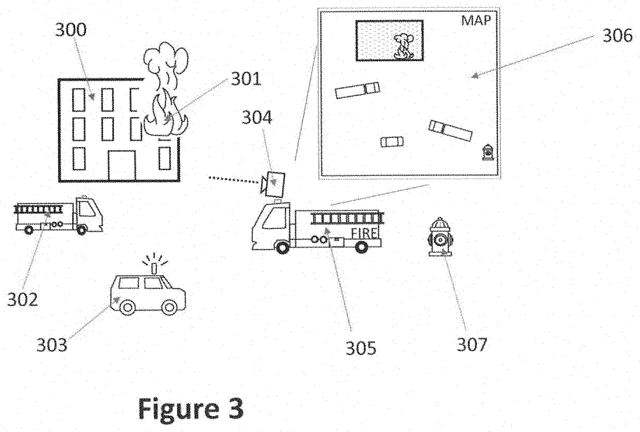

FIG. 3 shows that the autonomous fire vehicle (305) can use its sensors (304) to create a map (306) of the area, including location and type of buildings (300) which have a fire (301), vehicles (302, 303), people, vegetation, etc. This map (306) can be used internally by the autonomous fire vehicle (305) or sent to others, including a remote incident commander. This map (306) can be used to coordinate different equipment and vehicles, either manned or unmanned. The autonomous fire vehicle (305) gets its water source from the fire hydrant (307) shown in the figure.

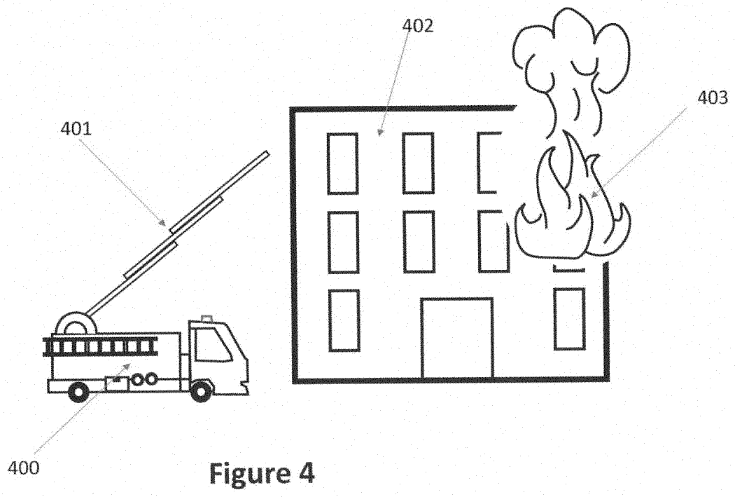

FIG. 4 shows that the autonomous fire vehicle (400) can control an automated ladder (401) to reach desired locations. The location can be computed automatically or selected by a human, either on site or remote. The automated ladder (401) is used to reach the top of a building (402) in which there is a fire (403) present.

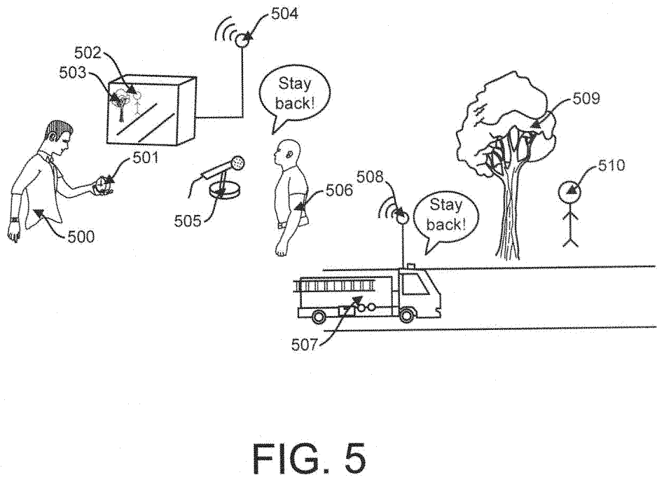

FIG. 5 shows that the autonomous fire vehicle (507) can have an external speaker to signal other vehicles or people. It has a sensor attached to it (508). The autonomous fire vehicle (507) can be teleoperated by a remote operator (500) who sends steering commands (501), speed commands, etc. Another remote operator (506) controls the external speaker (505).

Since the autonomous fire vehicle needs to reach the destination of the fire quickly in an emergency, there are special rules that it can follow compared to other types of vehicles. For example, a stop sign could become a yield sign and a red light can become a yield sign. In an emergency, the autonomous fire vehicle will have its flashing lights on and a siren to warn people to pull over so it can move ahead of the oncoming traffic. Also, it can become more aggressive in terms of changing lanes compared to the standard rules of the road. These special rules apply only in the case where there are emergencies. In non-emergency situations, the autonomous fire vehicles follows the normal rules of the roads like all other vehicles.

The autonomous fire vehicle will be designed to perform many of the duties that are currently performed by human fire fighters. These duties include driving fire trucks and other emergency vehicles, putting out fire using hoses, fire extinguishers, and pumps, finding and rescuing victims in burning buildings or in other emergency situations. Automated fire hose nozzles will be used to put out fires by the autonomous fire vehicles. Robotic stretchers could be used to rescue victims that are caught in the burning fire.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

The embodiments of the invention in which an exclusive property or privilege is claimed are defined as follows:

1. An autonomous fire vehicle designed to follow routes comprising:
an autonomous vehicle that includes a drive by wire kit;
a database storing the collection routes;
a database of rules of the road and/or other legal allowable behavior sensors for detecting the pedestrians, cars and other road obstacles;
a control system that controls the vehicle to follow routes while performing one or more of the following functions:
Detecting water supplies. Fire hydrant or other sources of water suitable for firefighting
Detecting the location of a fire
Detecting the location of other fire/police/first responder vehicles
Detection of smoke
Analysis of smoke/fire content to determine type of fuel being burned

2. The autonomous fire vehicle of claim 1 where the autonomous system is provided the location of the fire from an emergency signal/call/communication for help or an alarm, and the vehicle uses the road network to chart and follow a route that minimizes the time to the fire location while still following rules of the road

3. The autonomous fire vehicle of claim 1 where the vehicle after recognizing the location of the water supplies automatically positions the vehicle in a position that will find a position and park in that position taking under consideration the distance from the fire and the source of water.

4. The autonomous fire vehicle of claim 1 where the vehicle is further equipped with a mechanism that allows it to automatically direct a stream of water to the source or above it. The autonomous fire vehicle then uses the fire detection and localization to point the firehose and spicket towards the fire. The system adjusts the bearing and tilt of the water hose as well as control the water flow to aim at the water at the fire

5. The autonomous fire vehicle of claim 1 where the system has air composition sensors to detect the fuel being burned in the fire and has a system for determining the recommended fire extinguishing method: water vs powder vs other firefighting mixtures

6. The autonomous fire vehicle of claim 1 where the vehicle is equipped with speakerphones that are used to direct humans out of the area before the firefighting actions

7. The autonomous fire vehicle of claim 1 where the vehicle uses its own sensors to create a map of the area. The map can contain doorways, windows, locations of other vehicles, location of trees/vegetation, location of sources of fuel, location of humans/animals. The system is capable of creating a report that can help the local or remote incident commander understand the scene, and aid with the firefighting

8. The autonomous fire vehicle of claim 1 where a group of autonomous vehicles can partition the space as to attack the fire from different directions. The directions of attack is optimized by an expert system using the map collected of the area, can be predetermined based on the building or can be provided by an incident commander.

9. The system in claim 1 where the water stream is adjusted depending on the structure type and the location of windows. For example, the vehicle may point the water stream to windows and doorways, or at holes in the roof of the building.

10. The autonomous fire truck of claim 1 where two or more autonomous vehicles can adjust their streams to increase the water throughput in a particular area.

11. The autonomous fire vehicle of claim 1 where the truck can control bearing/tilt/extension of a ladder towards a window, balcony or roof of the building. The decision of when to extend the ladder can be performed by commands from a remote/local incident commander or aided by the human detection algorithms inherent to the vehicle.

12. The autonomous fire vehicle in claim 1 where the autonomous truck in route to the incident has a set of emergency rules that allows it to overcome the standard rules of the road. For example, these extended set of rules may allow the truck to cross a red traffic signal while in this emergency modality, exceed the speed limit or cross into oncoming traffic or block the road to other vehicles to stop.

13. The autonomous fire truck of claim 1 where the autonomous system collects evidence in the form of video/pictures/audio or other sensor information to provide after action review mechanisms to understand the cause of the fire.

14. The autonomous fire truck of claim 1 where the autonomous system can send information to other vehicles in the vicinity to move out of the way, park by the side of the road or open a lane

15. The autonomous fire vehicle of claim 1 where the where a remote fire/police officer can remotely take over the autonomous truck. The remote operator may talk though a speakerphone, or teleoperate the steering and/or acceleration and break of the autonomous truck

16. The autonomous fire vehicle of claim 1 where the autonomous system can illuminate an area where the fire/smoke is detected

17. The system of claim 1 where the autonomous system can call an ambulance other fire/rescue vehicle given the particular detection

18. The autonomous fire vehicle of claim 1 where the autonomous system where the information of the detection, location, license plate, video, pictures, audio, and/or other sensor information is used to generate a report and sent to a centralized headquarters

19. The autonomous fire vehicle of claim 1 where the autonomous system has fire personal onboard that is performing tasks unrelated to driving

20. The autonomous fire vehicle of claim 1 where the autonomous system where sensors necessary for autonomous mobility are also used for the detections in claim 1

21. The autonomous fire vehicle of claim 1 or 2 where the detections of claim 1 are performed using cameras or thermal imagery or LADAR.

22. The autonomous fire vehicle of claim 1 or 2 where the detections of claim 1 are performed by using deep learning or other learning techniques are used to improve the classification capabilities of the system

23. The autonomous fire vehicle of claim 1 or 2 where the autonomous system is directed to areas that have more crime, more tickets, more probability of finding someone committing an infraction

24. The autonomous fire vehicle of claim 1 or 2 where the autonomous system also has a database of areas where to station in order to minimize response time. For example, the system may park close to a factory complex that is further away from a fire station and wait until called in action.
